(19) United States
(12) Patent Application Publication
(10) Pub. No.: US 2024/0305703 A1
(43) Pub. Date: Sep. 12, 2024

(54) SYSTEMS AND METHODS FOR PROVIDING PROTOCOL ACCELERATOR PROXY SERVICES

(71) Applicant: JPMORGAN CHASE BANK, N.A., New York, NY (US)

(72) Inventors: Ankitkumar PATEL, Dublin, OH (US); Anatoliy LELIKOV, Columbus, OH (US)

(21) Appl. No.: 18/597,444

(22) Filed: Mar. 6, 2024

Related U.S. Application Data
(60) Provisional application No. 63/489,275, filed on Mar. 9, 2023.

(51) Int. Cl. H04L 69/18; H04L 67/02; H04L 69/16

(52) U.S. Cl. CPC H04L 69/18; H04L 67/02; H04L 69/16

(57) ABSTRACT

In some embodiments, the techniques described herein relate to a method including: receiving, at a first protocol accelerator proxy, a data communication, wherein the data communication is received from a first computer application, wherein the data communication is received via a first protocol, and wherein data received with the data communication is formatted for transport by the first protocol; reformatting, by the first protocol accelerator proxy, the data received with the data communication to be sent with a second protocol; sending the data received with the data communication to a second protocol accelerator proxy; reformatting, by the second protocol accelerator proxy, the data received with the data communication to be sent with the first protocol; sending the data received with the data communication to a second computer application via the first protocol.

### RELATED APPLICATIONS

This application claims the benefit of U.S. provisional patent application Ser. No. 63/489,275, filed Mar. 9, 2023, the disclosure of which is incorporated by reference herein in its entirety.

### BACKGROUND

### 1. Field of the Disclosure

Embodiments of this disclosure generally relate to systems and methods for providing protocol accelerator proxy services.

### 2. Description of the Related Art

Version 1.0 or version 1.1 of the hypertext transfer protocol (HTTP) is still commonly used today to facilitate data exchanges between systems (e.g., in client-server and system-to-system communications). These versions of HTTP rely on the Transmission Control Protocol (TCP) as an underlying protocol. TCP provides reliable, error-checked data communication between applications. TCP, however, is connection oriented, requires a three-way handshake (active open), provides for retransmission, and provides for error detection. While these features add to the reliability and robustness of TCP, they also introduce latency. Moreover, in order to secure data transported over HTTP, a security protocol (e.g., transport layer security (TLS) 1.2) is used on top of HTTP 1.1, which, in turn, adds additional overhead. When transferring larger data payloads over a long distance, the above configuration may significantly impact transmission times.

While the use of more efficient modern protocols (e.g., HTTP 3.0, which no longer requires the use of the TCP protocol as an underlying protocol, but rather uses user datagram protocol (UDP), which does not handshake or utilize roundtrips) can reduce latency, incorporation of such protocols into legacy systems can be cost prohibitive or even impossible.

### SUMMARY

Systems and methods for providing protocol accelerator proxy service are disclosed. In one embodiment, a method may include: (1) receiving, at a first protocol accelerator proxy, a data communication, wherein the data communication may be received from a first computer application, wherein the data communication may be received via a first protocol, and wherein data received with the data communication may be formatted for transport by the first protocol; (2) reformatting, by the first protocol accelerator proxy, the data received with the data communication to be sent with a second protocol; (3) sending the data received with the data communication to a second protocol accelerator proxy; (4) reformatting, by the second protocol accelerator proxy, the data received with the data communication to be sent with the first protocol; and (5) sending the data received with the data communication to a second computer application via the first protocol.

In one embodiment, the first protocol may be version 1.0 or version 1.1 of the hypertext transport protocol (HTTP).

In one embodiment, the second protocol may be version 3.0 of HTTP.

In one embodiment, the first computer application may be a client application.

In one embodiment, the second computer application may be a server application.

In one embodiment, a transport layer protocol underlying the first protocol may be a transmission control protocol (TCP).

In one embodiment, a transport layer protocol underlying the second protocol may be a user datagram protocol (UDP).

According to another embodiment, a system may include a source site comprising a source system and a first protocol accelerator proxy and a destination site comprising a destination system and a second protocol accelerator proxy. The first protocol accelerator proxy may be configured to receive a data communication from the source system via a first protocol, the data communication comprising data formatted for transport by the first protocol; to reformat the data for transport by a second protocol; and to send the data formatted for transport by the second protocol to a second protocol accelerator proxy; and the second protocol accelerator proxy may be configured to receive the data formatted for transport by the second protocol; to reformat the data formatted for transport by the second protocol for transport by the first protocol, and to send the data formatted for transport by the second protocol for transport by the first protocol to the destination system via the first protocol.

In one embodiment, the first protocol may be version 1.0 or version 1.1 of the hypertext transport protocol (HTTP).

In one embodiment, the second protocol may be version 3.0 of HTTP.

In one embodiment, the first computer application may be a client application.

In one embodiment, the second computer application may be a server application.

In one embodiment, a transport layer protocol underlying the first protocol may be a transmission control protocol (TCP).

In one embodiment, a transport layer protocol underlying the second protocol may be a user datagram protocol (UDP).

According to another embodiment, a non-transitory computer readable storage medium may include instructions stored thereon, which instructions, when read and executed by one or more computer processors, cause the one or more computer processors to perform steps comprising: receiving a data communication from a first computer application via a first protocol, and wherein data received with the data communication may be formatted for transport by the first protocol; reformatting the data received with the data communication to be sent with a second protocol; reformatting the data received with the data communication to be sent with the first protocol; and sending the data received with the data communication to a second computer application via the first protocol.

In one embodiment, the first protocol may be version 1.0 or version 1.1 of the hypertext transport protocol (HTTP).

In one embodiment, the second protocol may be version 3.0 of HTTP.

In one embodiment, the first computer application may be a client application.

In one embodiment, the second computer application may be a server application.

In one embodiment, a transport layer protocol underlying the first protocol may be a transmission control protocol (TCP).

In one embodiment, a transport layer protocol underlying the second protocol may be a user datagram protocol (UDP).

### BRIEF DESCRIPTION OF THE DRAWINGS

FIG. 1 illustrates a block diagram of a system for providing protocol accelerator proxy services, in accordance with embodiments.

FIG. 2 illustrates a logical flow for providing a protocol accelerator proxy service, in accordance with embodiments.

FIG. 3 illustrates a block diagram of a technology infrastructure and computing device for implementing certain embodiments of the present disclosure.

Before explaining the disclosed embodiment of the subject disclosure in detail, it is to be understood that the invention is not limited in its application to the details of the particular arrangement shown, since the invention is capable of other embodiments. Example embodiments are illustrated in referenced figures of the drawings. It is intended that the embodiments and figures disclosed herein are to be considered illustrative rather than limiting.

### DETAILED DESCRIPTION

As shown in the figures, embodiments of this disclosure generally relate to systems and methods for providing protocol accelerator proxy services.

Embodiments described herein may reduce the number of round trips required by network communications, and may significantly reduce overall response time, particularly for data transmissions over long physical distances where some legacy systems may require the use of legacy protocols.

A protocol accelerator proxy (PAP) may be implemented between two communicating systems in order to reduce latency. Two PAPs may be hosted, one PAP near the source of the traffic and the other PAP near the destination. PAPs may preserve the use of existing established legacy protocols for communication between legacy systems while facilitating more efficient protocols over wide area network (WAN) connections. Network latency within a hosting site will generally be negligible, so the use of legacy protocols within a hosting site, data center, etc., from a source system and to a PAP will not add significant latency to an overall transmission time. PAPs may be configured to use modern protocols for communicating between sites and may further be configured to perform all legacy-to-modern, and back to legacy, protocol upgrade/downgrade procedures, thereby shielding legacy systems from configuration and protocol changes.

Commercial applications are generally provided with a communications protocol stack that is not customizable by end consumers of the applications. Accordingly, application consumers are not able to select modern optimized communication protocols for use with commercial applications, because the applications will not support the use of such protocols. Consequently, a commercial application, and particularly legacy applications that are still in use, are relegated to communication over antiquated and suboptimal communication protocols.

A PAP may intercept network traffic from an application on a local network before the traffic exits a local gateway and is transmitted over a wide-area network (WAN) connection. That is, a PAP may be configured as, and operate as, a gateway to a public or private WAN connection, e.g., for legacy systems using legacy protocols. An application may be configured to use a PAP as a network gateway and may send network traffic destined for a location outside of the local network environment to the PAP. The PAP may receive the local network traffic, reformat the traffic's payload for transmission across the WAN connection using different (e.g., more modern, efficient network communication protocol(s)), and may send the payload across the WAN connection to the destination using the different/upgraded protocol(s).

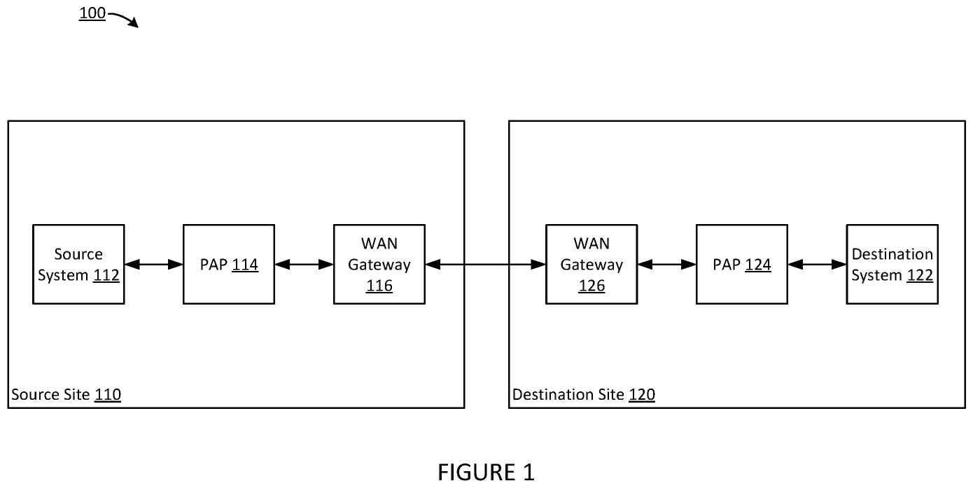

FIG. 1 illustrates a block diagram of a system for providing protocol accelerator proxy services, in accordance with embodiments. System 100 may include source site 110 and destination site 120. Both source site 110 and destination site 120 may be local area networks (LANs) where computing devices are in operative communication with each other over high-speed LAN connections such as gigabit ethernet, or similar high-speed mediums. Both source site 110 and destination site 120 may be part of an implementing organization's technology infrastructure.

Source site 110 may include source system 112, PAP 114, and WAN gateway 116. Destination site 120 may include destination system 122, PAP 124, and WAN gateway 126. Communication between source site 110 and destination site 120 may be facilitated via a WAN connection. A WAN connection may be any suitable combination of public and/or private network infrastructures with any suitable protocols or protocol stacks for transferring data from source site 110 over the WAN connection and to destination site 120. A WAN connection between source site 110 and destination site 120 may be a dedicated private connection or it may be facilitated via a virtual private connection over a public network such as the internet. For instance, WAN gateway 116 and WAN gateway 126 may be configured to transmit traffic over a WAN connection using HTTP version 3.0 communication along with a suitable transport-level protocol and any other necessary or desired protocols.

In some embodiments, source system 112 may be configured as an HTTP client that uses, e.g., version 1.1 of the HTTP protocol for network communication. Likewise, destination system 122 may be configured as an HTTP server and may also be configured to use version 1.1 of the HTTP protocol for network communication. Source system 112 may be configured to send network communications to destination system 122 and destination system 122 may be configured to respond, each using version 1.1 of the HTTP protocol (i.e., HTTP 1.1).

In conventional systems, source system 112 may be configured to use WAN gateway 116 directly and WAN gateway 116 may send data using the HTTP 1.1 protocol across the WAN connection to WAN gateway 126, which may forward the data (e.g., a request for service) directly to destination system 122. Destination system 122 may respond in a similar fashion sending a response directly to WAN gateway 126 for transmission to WAN gateway 116 and then on to source system 112. Due to the inefficiencies of HTTP 1.1, latency across the WAN connection may be high, thus negatively impacting performance of the systems.

In some embodiments, PAP 114 may be configured to receive traffic and perform a protocol upgrade procedure before sending traffic across a WAN connection. Source system 112 may be configured to use PAP 114 as a network gateway. In a network gateway configuration, PAP 114 may intercept traffic from source system 112 before the traffic reaches WAN gateway 116 and is routed across the WAN connection. Source system 112 may format a data payload addressed for destination system 122 using a legacy, upper-layer protocol (e.g., an application layer protocol such as version 1.1 of the HTTP protocol). Source system 112 may further use a security protocol (e.g., transport layer security (TLS) 1.2) to secure network traffic. Source system 112 may also use an underlying, lower-level protocol (e.g., a transport layer protocol such as transmission control protocol (TCP)) in conjunction with the upper-layer protocol and any security protocol. Source system 112 may be configured to send the data payload to PAP 114, which may be configured as the network gateway for source system 112.

PAP 114 may be configured to receive data from source system 112. PAP 114 may receive the data payload at a local-facing network interface configured to receive TCP packets and may construct the HTTP payload from a number of received TCP packets. PAP 114 may then reformat the HTTP payload (e.g., an HTTP request) as an HTTP version 3.0 communication. A WAN-facing network interface of the PAP may then send the HTTP version 3.0 communication as a series of User Datagram Protocol (UDP) packets to destination site 120. In some embodiments, a WAN-facing network interface of PAP 114 may be configured to forward traffic to WAN gateway 116. In other embodiments, a WAN-facing network interface may be configured to communicate traffic directly across a WAN connection. In still other embodiments, PAP 114 may have a single network interface that both receives data from source system 112 and forwards data on (e.g., to WAN gateway 116).

Data originating from a source system, such as source system 112, may be received at destination site 120 in an upgraded protocol format (e.g., HTTP 3.0 over UDP, as discussed above). In some embodiments, WAN gateway 126 may receive data and forward the data to PAP 124. In other embodiments, PAP 124 may receive data from a WAN connection directly via a WAN-facing network interface. In still other embodiments, PAP 124 may send and receive data via a single network interface.

PAP 124 may receive data destined for destination system 122 in an upgraded protocol format. For example, PAP 124 may receive a series of UDP packets and may construct an HTTP 3.0 communication (e.g., an HTTP request) from the UDP packets. PAP 124 may then downgrade the protocol to a legacy protocol before forwarding the data/communication. For example, PAP 124 may reformat the HTTP 3.0 request as an HTTP 1.1 request and may send the HTTP 1.1 request as a series of TCP packets from a local-facing network interface to destination system 122.

Destination system 122 may receive the communication in the legacy format in which destination system 122 is configured to receive data (e.g., HTTP 1.1 over TCP using TLS 1.2 for security) and process the data appropriately. In the case where destination system 122 will format a response (e.g., if destination system 122 is a server and will respond to a received request), the components of system 100 may work as described in a reverse fashion. That is, destination system 122 may format a response to a received communication and may send the response, formatted in a legacy protocol, as described herein, to PAP 124, which may be configured to receive LAN traffic from destination system 122. For instance, PAP 124 may be configured as a WAN gateway for destination system 122. PAP 124 may execute a protocol upgrade procedure on the received data, as described herein, and may send the upgraded response communication across a WAN connection (e.g., via WAN gateway 126). PAP 114 may receive the response communication, downgrade the protocol, and forward the response data over the downgraded protocol to source system 112.

Accordingly, embodiments described herein may provide modern and efficient communication protocols at various networking/application layers across WAN connections. Thus, instead of having to rely on a legacy communication protocol, which may introduce latency issues, modern protocols may be used to send data payloads across the most latency-sensitive network leg—the WAN connection leg. Moreover, a response may be transmitted in like fashion by reversing the upgrade and downgrade functions of the relevant PAP components, as described herein.

A PAP may take the form of one or more applications, servers, application containers, etc., executing on a local area network (LAN). A PAP may be configured with appropriate network interfaces (e.g., network interface cards (NICs) for both local and wide area network topologies and protocols. Additionally, a PAP may be configured with appropriate software libraries and logic to receive network communications at a LAN interface of the PAP, deconstruct the communication into the original data payload (e.g., a byte stream), and then build the original data payload into a network communication using other (e.g., more modern and/or efficient) network protocols at various layers, as described above.

PAPs may be advantageously implemented where a network communication will be transmitted over a WAN connection for a long physical distance, where reducing a total number of round-trip communications (e.g., handshakes performed by the TCP protocol) may result in a substantial reduction in latency.

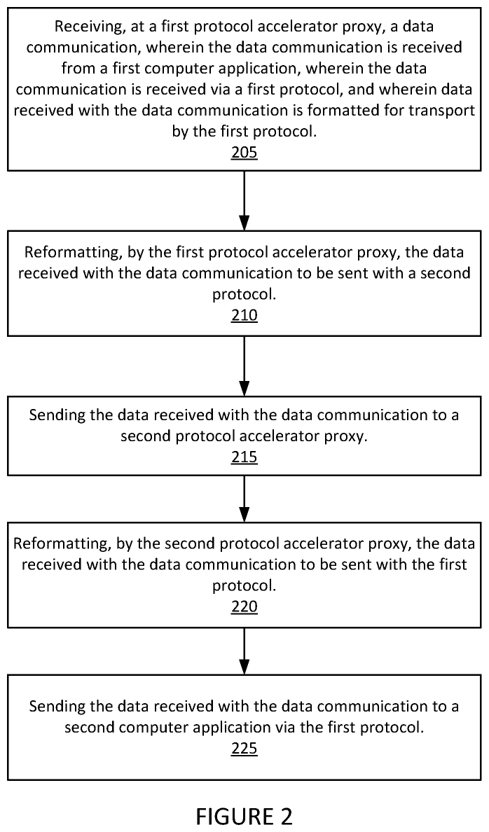

FIG. 2 illustrates a logical flow for providing a protocol accelerator proxy service, in accordance with some embodiments.

Step 205 includes receiving, at a first protocol accelerator proxy, a data communication, wherein the data communication is received from a first computer application, wherein the data communication is received via a first protocol, and wherein data received with the data communication is formatted for transport by the first protocol.

Step 210 includes reformatting, by the first protocol accelerator proxy, the data received with the data communication to be sent with a second protocol.

Step 215 includes sending the data received with the data communication to a second protocol accelerator proxy.

Step 220 includes reformatting, by the second protocol accelerator proxy, the data received with the data communication to be sent with the first protocol.

Step 225 includes sending the data received with the data communication to a second computer application via the first protocol.

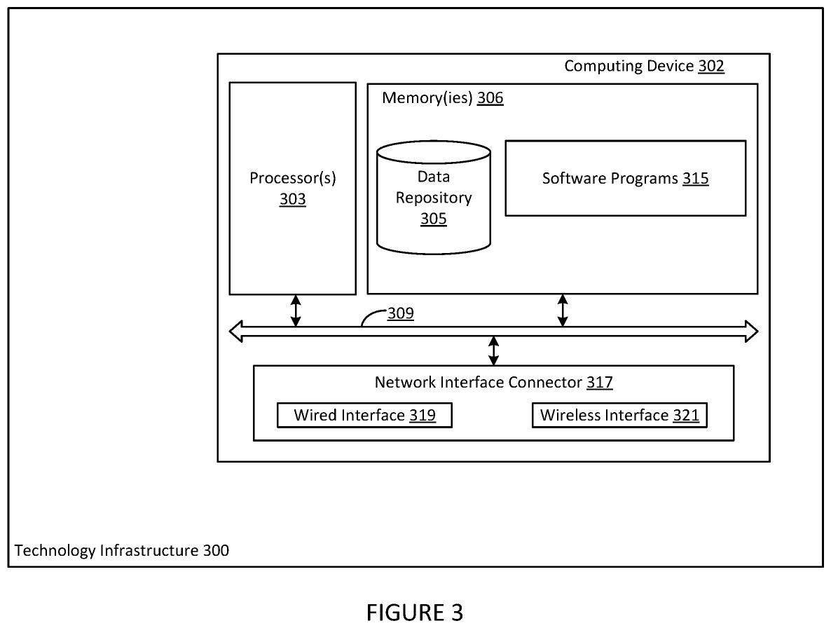

FIG. 3 illustrates a block diagram of a technology infrastructure and computing device for implementing certain embodiments of the present disclosure, in accordance with some embodiments.

As illustrated in FIG. 3, a technology infrastructure 300 may be provided that represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with embodiments, system components such as a source system, a PAP, a WAN gateway, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at a first protocol accelerator proxy, a data communication, via a first protocol, wherein the data communication is received from a first computer application, and wherein data received with the data communication is formatted for transport by the first protocol;
reformatting, by the first protocol accelerator proxy, the data received with the data communication to be sent with a second protocol;
sending the data received with the data communication to a second protocol accelerator proxy;
reformatting, by the second protocol accelerator proxy, the data received with the data communication to be sent with the first protocol; and
sending the data received with the data communication to a second computer application via the first protocol.

2. The method of claim 1, wherein the first protocol is version 1.0 or version 1.1 of the hypertext transport protocol (HTTP).

3. The method of claim 2, wherein the second protocol is version 3.0 of HTTP.

4. The method of claim 1, wherein the first computer application is a client application.

5. The method of claim 4, wherein the second computer application is a server application.

6. The method of claim 1, wherein a transport layer protocol underlying the first protocol is a transmission control protocol (TCP).

7. The method of claim 1, wherein a transport layer protocol underlying the second protocol is a user datagram protocol (UDP).

8. A system, comprising:
a source site comprising a source system and a first protocol accelerator proxy;
a destination site comprising a destination system and a second protocol accelerator proxy;
wherein the first protocol accelerator proxy is configured to receive a data communication from the source system via a first protocol, the data communication comprising data formatted for transport by the first protocol; to reformat the data for transport by a second protocol; and to send the data formatted for transport by the second protocol to a second protocol accelerator proxy; and
the second protocol accelerator proxy is configured to receive the data formatted for transport by the second protocol; to reformat the data formatted for transport by the second protocol for transport by the first protocol, and to send the data formatted for transport by the second protocol for transport by the first protocol to the destination system via the first protocol.

9. The system of claim 8, wherein the first protocol is version 1.0 or version 1.1 of the hypertext transport protocol (HTTP).

10. The system of claim 9, wherein the second protocol is version 3.0 of HTTP.

11. The system of claim 8, wherein the source system comprises a client application.

12. The system of claim 11, wherein the destination system comprises a server application.

13. The system of claim 8, wherein a transport layer protocol underlying the first protocol is a transmission control protocol (TCP).

14. The system of claim 8, wherein a transport layer protocol underlying the second protocol is a user datagram protocol (UDP).

15. A non-transitory computer readable storage medium, including instructions stored thereon, which instructions, when read and executed by one or more computer processors, cause the one or more computer processors to perform steps comprising:
receiving a data communication from a first computer application via a first protocol, and wherein data received with the data communication is formatted for transport by the first protocol;
reformatting the data received with the data communication to be sent with a second protocol;
reformatting the data received with the data communication to be sent with the first protocol; and
sending the data received with the data communication to a second computer application via the first protocol.

16. The non-transitory computer readable storage medium of claim 15, wherein the first protocol is version 1.0 or version 1.1 of the hypertext transport protocol (HTTP).

17. The non-transitory computer readable storage medium of claim 16, wherein the second protocol is version 3.0 of HTTP.

18. The non-transitory computer readable storage medium of claim 15, wherein the first computer application is a client application, and the second computer application is a server application.

19. The non-transitory computer readable storage medium of claim 15, wherein a transport layer protocol underlying the first protocol is a transmission control protocol (TCP).

20. The non-transitory computer readable storage medium of claim 15, wherein a transport layer protocol underlying the second protocol is a user datagram protocol (UDP).
